(19) United States
(12) Patent Application Publication
(10) Pub. No.: US 2026/0295650 A1
(43) Pub. Date: Oct. 1, 2026

(54) MANUFACTURING METHOD FOR A METALLIC PART AND ASSOCIATED METALLIC PART

(71) Applicant: ArcelorMittal, Luxembourg (LU)

(72) Inventors: Jean-Marc DEVIN, CHANTILLY (FR); Nicolas SCHNEIDER, Saint-Martin-Longueau (FR); Patrick DUROUX, Bourgoin-Jallieu (FR)

(21) Appl. No.: 19/478,678

(22) PCT Filed: May 15, 2024
(86) PCT No.: PCT/IB2024/054721

§ 371 Date: Oct. 24, 2025

(30) Foreign Application Priority Data
May 15, 2023 (WO) PCT/IB2023/054979

(51) Int. Cl. B21D 22/26; B21D 22/02; B21D 35/00; B21D 47/04; B21D 53/88

(52) U.S. Cl. CPC B21D 22/26; B21D 22/02; B21D 35/007; B21D 47/04; B21D 53/88

(57) ABSTRACT

A stamping method to form a metallic part and associated metallic part, wherein the geometry of the metallic part is such that some areas need to deform in antagonistic directions during stamping. The stamping method includes the step of providing a flexible metallic blank including at least two sub-blanks corresponding to sub-parts of the metallic part, the flexible blanks further including an overlapping area in which the blanks are overlapped onto one another, the overlapping area corresponding to the critical transition area between the two sub-parts, the overlapping area including a fixed pre-assembly area and a sliding area. The punch used for the stamping operation includes a gap in between the area of the punch corresponding to the first and second sub-parts.

The present invention relates to a process to manufacture a metallic part and the associated metallic part. In particular, it relates to the manufacturing of complex metallic parts in which the forming is performed by stamping.

### BACKGROUND

There is a growing demand in the metallic part manufacturing industry, in particular in the automotive part manufacturing industry, to produce parts having ever more complex shapes. This allows for instance to integrate several separate individual parts into one single part. This streamlines the production process: only one forming operation replaces the combination of several separate forming operations to produce the individual sub-parts and the corresponding joining process to assemble said individual sub parts. This also allows to improve part performance because the assembly points between individual sub parts are often weak points that can fail under load, for example when a crash occurs in the case of automotive parts. Furthermore, the simplification of the production process entails further positive effects such as the reduction of green-house gas emissions during forming and cost reductions.

### SUMMARY OF THE INVENTION

Stamping is a well-known sheet metal forming technique which consists of pressing a flat metallic sheet between an upper and a lower die generally having the shape of the formed metallic part. Said dies move relative to one another in a direction termed the stamping direction.

During stamping, the pressed metal flows under the joint forces exerted by the upper and lower dies. It is generally not possible to stamp a part if there are abrupt transitions of the direction in which the metal flows. Indeed, in the areas where these abrupt transitions occur, the metal sheet needs to flow in two distinct directions, which leads to very high deformation rates, excessive thinning and eventually the occurrence of cracks. In some instances this also leads to wrinkling of the part.

This limits the diversity of shapes accessible by the traditional stamping process. Japanese patent application JP2007029966 provides a first solution to manufacture complex metallic parts by stamping. The proposed solution is to provide a metallic blank which is an assembly of several sub-blanks partly overlapping each other in such a way that the sub-blanks can move relative to one another in the overlapping regions during stamping. Thus, in the areas where the metallic blanks need to flow in two distinct directions, each of the two overlapping sub-blanks are free to move in said distinct directions, seemingly solving the issue of excessive thinning, cracking and wrinkling.

However, the inventors have met serious issues of excessive thinning, cracking and folding when trying to apply in practice the teachings of JP2007029966 as will be demonstrated in the examples below.

It is an object of the current invention to provide a metallic part forming process allowing to stamp complex shapes in which the sheet metal needs to flow in several distinct directions without the occurrence of excessive thinning, cracking or folding. A further object of the present invention is to provide a part made according to the inventive process and having a complex shape, not reachable using current state of the art stamping technology.

The present invention provides a manufacturing process to produce a metallic part (1) by stamping a flexible metallic blank (10) according to a stamping direction(S),
said metallic part (1) comprising at least:
   a first sub-part (11) generally extending along a first direction (D1), perpendicular to said stamping direction(S), and comprising at least one first side wall (111), substantially parallel to said stamping direction(S), connected to a first top section (113), generally extending in a plane perpendicular to said stamping direction(S),
   a second sub-part (12) connected to said first sub-part (11) and generally extending along a second direction (D2), perpendicular to said stamping direction(S) and forming with said first direction (D1) an angle α strictly greater than 0°, comprising at least two vertical walls (121, 122), substantially parallel to said stamping direction(S), and a second top section (123) connecting said two vertical walls (121, 122), generally extending in a plane perpendicular to said stamping direction(S),
said flexible metallic blank (10) comprising at least:
   two sub-blanks (101, 102) each substantially corresponding to said first and second sub-parts (11, 12),
   at least one overlap area (100) in which said sub-blanks (101, 102) overlap one another,
   said overlap area (100) comprising at least one sliding area (1001) in which said sub-blanks (101, 102) are free to slide on to one another during said stamping operation and a fixed pre-assembly area (1002) in which said sub-blanks (101, 102) cannot move relative to one another during the stamping operation,
said manufacturing process comprising at least the steps of:
   providing said at least two metallic sub blanks (101, 102),
   pre-assembling said at least two metallic sub blanks (101, 102) in said fixed pre-assembly area (1002) to form said flexible flat metallic blank (10),
   performing said stamping operation by pressing said flexible metallic blank (10) between a punch (2) and a die moving relative to one another in said stamping direction(S), wherein said punch (2) comprises at least one gap (4) in between the areas corresponding to said first and second sub-parts (101, 102).

The present invention also provides a metallic part (1) manufactured as described above.

The present invention also provides an automotive vehicle comprising at least one metallic part as described above.

### BRIEF DESCRIPTION OF THE DRAWINGS

Other aspects and advantages of the invention will appear upon reading the following description, given by way of example, and made in reference to the appended drawings, which are in no way limitative, wherein:

FIG. 1 is a perspective view of a specific embodiment of a metallic part for which the present invention provides a manufacturing process,

FIG. 2 is a top view of a flexible blank according to the current invention,

FIG. 3A is a top view of a punch and binder of a stamping tool according to the prior art and FIG. 3B of a punch and binder of a stamping tool according to the invention,

FIG. 4 is a perspective view of the start of a stamping operation according to the current invention,

FIG. 5 is a perspective view of the same stamping operation as in FIG. 4, representing this time the end of the stamping operation,

FIG. 6A is a top view of a punch and binder of a stamping tool according to the invention and FIG. 6B of a conforming tool according to a particular embodiment of the current invention,

FIG. 7 is perspective view of a further embodiment of a metallic part for which the present invention provides a manufacturing process,

FIG. 8 is perspective view of a further embodiment of a metallic part for which the present invention provides a manufacturing process,

FIGS. 9A and 9B are perspective views of metallic parts formed by prior art techniques and FIG. 9C is a perspective view of a metallic part formed according to the current invention,

FIG. 10A is a cross section of a flexible blank according to a specific embodiment of the invention taken along the cutting line AA represented on FIG. 2, FIG. 10B is a cross section of a metallic part according to an embodiment of the invention taken along the cutting line BB represented on FIG. 8, and

FIG. 11 is a perspective view of a specific embodiment of a metallic part for which the present invention provides a manufacturing process.

### DETAILED DESCRIPTION

In the following figures and description, the orientations and spatial references are all made using an X, Y, Z coordinates associated to the following directions:
X is a longitudinal direction in the horizonal plane, the X axis being oriented such that the X coordinates increase in the front to rear direction, i.e. a position located further back will have a higher X coordinate than a position located further in the front,
Y is a transverse direction in the horizontal plane, and
Z is an elevation direction, the Z axis being oriented such that the Z coordinates increase from a lower position to an upper position, i.e. a first position located below a second position will have a lower Z coordinate value.

The referential is represented in each figure. When the figure is a 2D flat representation, the axis which is outside of the figure is represented by a dot in a circle when it is pointing towards the reader and by a cross in a circle when it is pointing away from the reader, following established conventions.

In particular, the terms “top”, “up”, “upper”, “above”, “bottom”, “low”, “lower”, “below” etc. are defined according to the elevation direction. The terms “front”, “back”, “rear”, “forward”, backward” etc. are defined according to the longitudinal direction. The terms “left”, “right”, “transverse”, etc. are defined according to the transverse direction. The term “horizontal” refers to the orientation of the plane comprising the longitudinal and the transverse directions. The term “vertical” refers to any orientation comprising the elevation direction.

By “substantially parallel” or “substantially perpendicular” it is meant a direction
which can deviate from the parallel or perpendicular direction by no more than 15°.

A metallic sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it is meant the overall average thickness of the material making up the part after it has been formed into a 3-dimensional part from an initially flat sheet.

Tailor welded blanks are made by assembling together, for example by laser welding, several sheets or cut-out blanks of steel, known as sub-blanks, in order to optimize the performance of the part in its different areas, to reduce overall part weight, to reduce overall part cost and to reduce material scrap. The sub-blanks forming the tailor welded blanks can be assembled with or without overlap, for example they can be laser butt-welded (no overlap), or they can be spot-welded to one another (with overlap).

A flexible blank is a combination of several sub-blanks which includes overlapping regions allowing the sub-blanks to move in different directions during the forming operation.

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and at is the bending angle for thickness t:

$$α1.5 = ( α t \times √ t ) / √ 1.5$$

Cold stamping is a forming technology for metals which involves shaping a metallic sheet into a formed part by pressing it between an upper and lower die, called the cold stamping tool. For example, the cold stamping tool has a blank holder which allows to hold the metallic sheet on its sides. For example, the cold stamping tool consists of several steps, each involving an upper and lower die to produce complex shapes and/or to perform further operations such as punching holes in the part or trimming its sides.

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes than what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

A partial hardening hot stamping process is a hot stamping process in which the heat profile to which the blank is submitted is purposely tailored to be different in different areas of the blank, in order to obtain different material properties in these different areas at the end of the hot stamping process. For example, this allows to produce hot stamped parts using a single metallic blank made of a single material which will have different levels of hardness and elongation in different areas of the final part. For example, this allows to produce parts having soft zones and hard zones, said soft zones being able to deform under an impact load in order to absorb energy, whereas said hard zones will resist intrusion by resisting deformation. There are several different technologies to implement partial hardening. For example, the material can be heated at different temperatures in different areas of the blank, the higher temperature areas will be fully austenitic at the exit of the austenitizing furnace resulting in a very hard microstructure after hot stamping, whereas the lower temperature areas will have an intercritical ferrite/austenite microstructure at the exit of the austenitizing furnace resulting in a lower hardness microstructure after hot stamping. For example, the material can be quenched at different quenching speeds in different areas of the blank during the hot stamping step itself, the areas quenched at a higher quenching speed will have a higher hardness than those quenched at a lower speed.

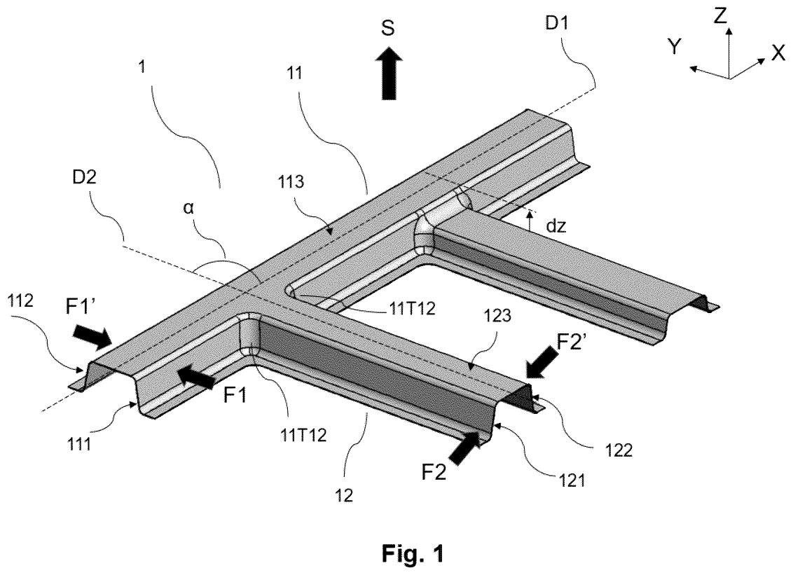

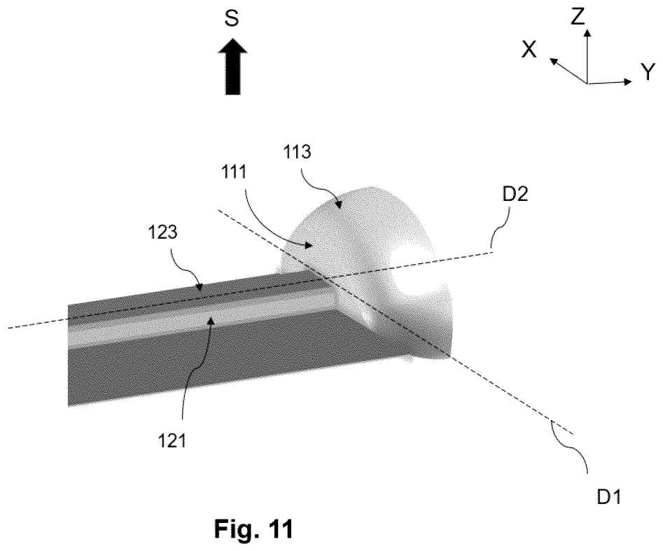

Referring to FIGS. 1 and 11, it is an object of the present invention to manufacture a metallic part 1 comprising at least the following sub-parts:
a first sub-part 11 generally extending along a first direction D1. In the rest of the description, this first direction will be conventionally chosen as the longitudinal direction. Said first direction is perpendicular to a stamping direction S, which will be in the current description conventionally chosen as the elevation direction, and comprising at least one first side wall 111 (in the case of FIG. 1 there are two side walls 111 and 112), substantially parallel to said stamping direction, and a first top section 113 linked to at least said one first side wall 111, and generally extending in a plane perpendicular to said stamping direction S,
a second sub-part 12 connected to said first sub part 11 and generally extending along a second direction D2, also perpendicular to said stamping direction and forming with said first direction an angle α strictly greater than 0°, comprising at least two vertical walls 121 and 122, substantially parallel to said stamping direction, and a second top section 123, connecting said two vertical walls 121, 122, generally extending in a plane perpendicular to said stamping direction.

The metallic part 1 represented in FIG. 1 is a particular embodiment in which the sub parts are generally omega shaped with straight vertical walls and straight flat top sections. This however is not limitative of the invention, the sub parts can for example have a curved inverted U-shape cross section, i.e. have curved vertical walls and a top section which is limited to a two dimensional line. This is for example the case of the first sub part 11 of the metallic part 1 represented on FIG. 11.

In a specific embodiment, the angle α between the two main directions D1, D2 of the sub-parts 11, 12 is comprised from 30° to 90°, more specifically from 60° to 90°, even more specifically from 80° to 90°.

When forming the metallic part 1 by stamping a flat metallic blank along the stamping direction S, the first vertical wall 111 is formed by the flow of material in a direction F1, transverse to D1, as represented on FIG. 1. In the case when a the first sub part 11 also contains a second vertical wall 112, it is formed thanks to a material flow in direction F1′. Simultaneously, the material flows in opposing directions F2 and F2′, both transverse to D2 to form the vertical walls 121 and 122 of the second sub-part 12. In transition regions 11T12 between sub parts 11 and 12 the material needs to flow simultaneously in directions F1 and F2 or in directions F1 and F2′. The angle between said directions will be α or its complementary to 180° and since α is strictly greater than 0°, this leads to a simultaneous flow of material in different directions, which overstretches said material leading to excessive thinning and eventually cracking in the transition regions.

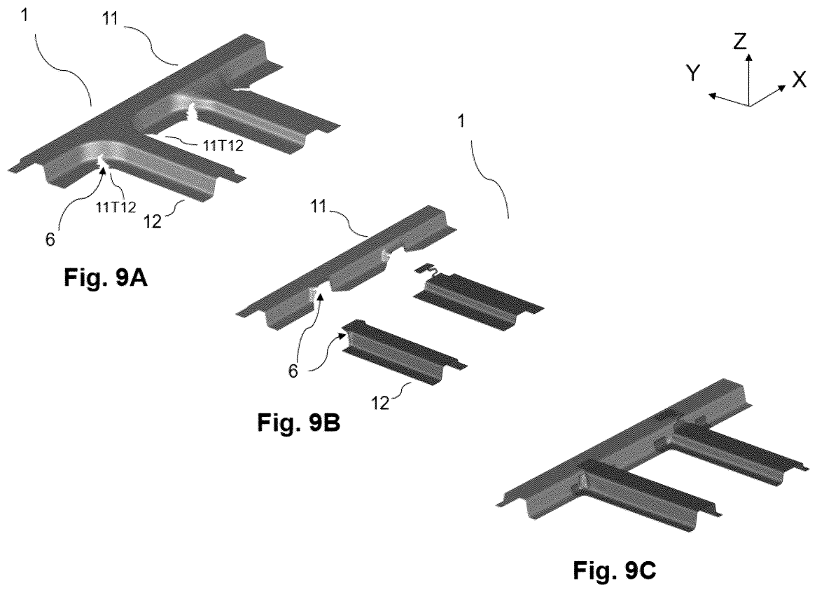

This is illustrated by FIG. 9A, which is an example of a stamping simulation of a metallic part corresponding to the above description, in which cracks 6 appear in the transition regions 11T12 due to the above-described competing deformation directions.

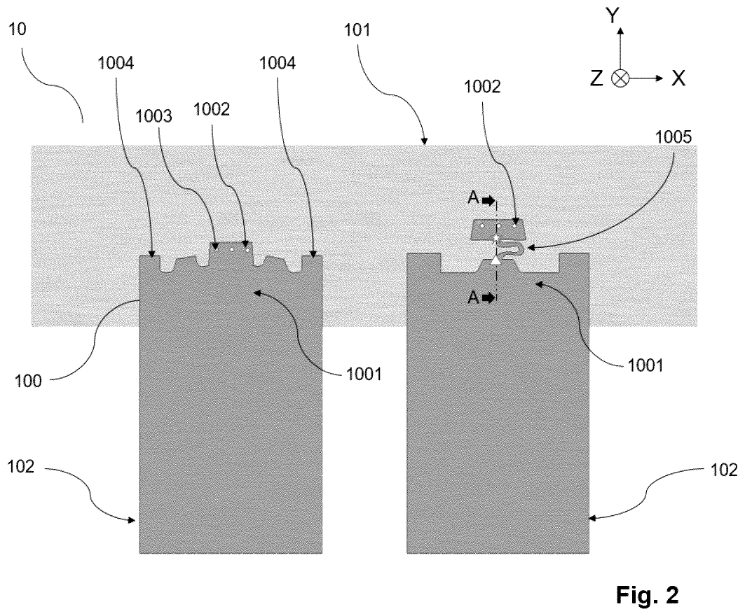

A first part of the solution to manufacture a metallic part according to the invention is to use a flexible blank 10, as depicted in FIG. 2. Said flexible blank 10 comprises at least:
two sub-blanks 101, 102 each substantially corresponding respectively to said first and second sub-parts 11, 12,
at least one overlap area 100 in which said sub-blanks 101, 102 overlap one another,
said overlap area 100 comprising at least one sliding area 1001 in which said sub-blanks 101, 102 are free to slide on to one another during said stamping operation and a fixed pre-assembly area 1002 in which said sub-blanks cannot move relative to one another during the stamping operation.

During the stamping operation, the area of the flexible blank corresponding to the transition regions 11T12 in which cracks normally occur is now double layered thanks to the presence of the overlap region 100, and both layers have the freedom to slide on to one another thereby preventing the above-described issue of excessive thinning and cracking due to contradictory material flow directions. For example, in the configuration of FIG. 1, the material of sub-blank 101 corresponding to the vertical wall 111 will be free to move in direction F1 while the material of sub-blank 102 corresponding to the vertical wall 121 and 122 will be free to move in directions F2 and F2′.

The inventors have found that, surprisingly, providing the above described flexible blank alone is not sufficient to manufacture a metallic part free of stamping defects in the transition regions 11T12. FIG. 9B is an exploded view of the result of performing a stamping operation on a flexible blank as described previously. Sub-parts 11 and 12 have been disassembled in order to highlight the forming issues that were encountered. As can be seen, cracks 6 appear both on the first and second sub parts 11, 12.

The inventors have found that it was possible to stamp a metallic part according to the invention by modifying the stamping process.

A stamping tool generally comprises a punch and a die. The die can be seen as a mold in which the part will be formed, while the punch is used to transfer the shape of the part to the blank by pressing it into the die in the stamping direction. A stamping tool can optionally further comprise a binder, also known as a blank holder, which is used to keep the blank in place during stamping and thus control the flow of material to reach a good quality shape.

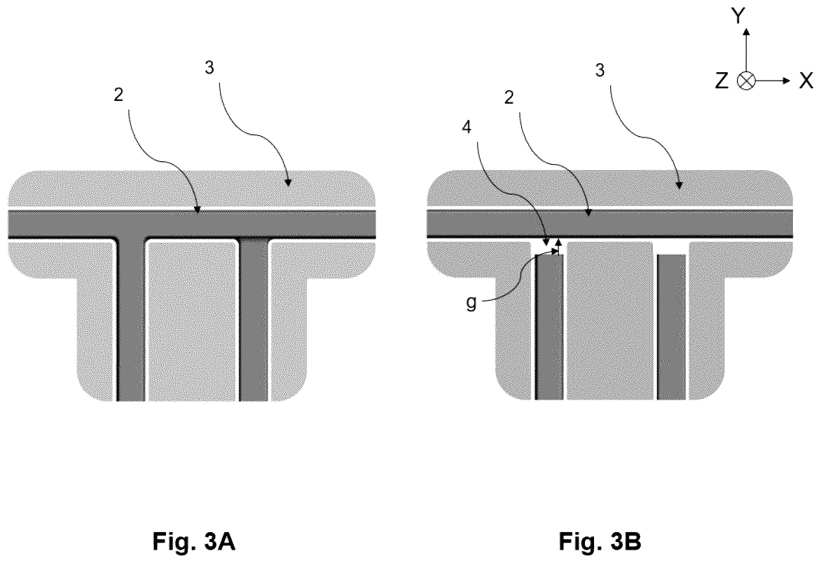

FIG. 3A is a top view of a punch 2 and a binder 3 according to the state of the art. Referring to FIG. 3B, the inventors have found that, surprisingly, it was possible to solve the cracking issue in the transition zones when using a flexible blank by providing a punch 2 having a gap 4 in between the areas of the punch corresponding to the first sub-part 11 and the second sub-part 12.

FIG. 9C is an example of a stamping simulation of a flexible blank according to the invention using a stamping tool according to the invention, i.e. with a gap 4 between the areas of the punch 3 corresponding to the first and second sub-parts. No cracks were observed in the transition areas 11T12 in this last simulation.

In a particular embodiment, the inventors have found that the necessary length of said gap 4 (i.e. the distance g indicated on FIG. 3B) is linked to the height of the vertical walls of the two contiguous sub-parts in the corresponding transition region 11T12. Indeed, the reason for which cracking occurs when no gap is provided is linked to the flow of material to form said vertical walls, and the amount of material flow is itself linked to the height of said vertical walls. Stamping a part with higher walls means that more material needs to flow to form said walls. Therefore, the higher the vertical walls, the bigger the necessary gap length. On the other hand, the necessary gap length g will never exceed the maximum height of the vertical walls, because as we move away from the connection between the two contiguous sub-parts, the effect of the transition region on the material flow diminishes and is close to none when the distance from the connection region starts to exceed the height of the vertical walls.

In a particular embodiment, the length g of the gap 4, expressed in mm, is greater than or equal to 30%, preferably 50%, preferably 70% of the height of the highest vertical wall in the transition region 11T12 and lower than or equal to said same height of the highest vertical wall in the transition region 11T12.

In summary, the inventors have found that it is possible to manufacture a metallic part having the above-described characteristics without the occurrence of excessive thinning or cracks in the transition zones by applying the following manufacturing process:
Provide at least two metallic sub blanks 101, 102 corresponding to the two sub-parts 11,12 of the metallic part 1,
Pre-assemble said at least two metallic sub blanks in a pre-assembly area to form a flexible metallic blank 10, said flexible blank comprising at least one overlap area 100 in which said sub-blanks overlap one another, said overlap area comprising at least one sliding area 1001 in which said sub-blanks are free to slide on to one another during said stamping operation and a fixed pre-assembly area 1002 in which said sub-blanks cannot move relative to one another during the stamping operation,
Perform a stamping operation by pressing said flexible metallic blank between a punch 2 and a die moving relative to one another in a stamping direction S, wherein said punch 2 comprises at least one gap 4 in between the areas corresponding to said first and second sub-parts 11, 12.

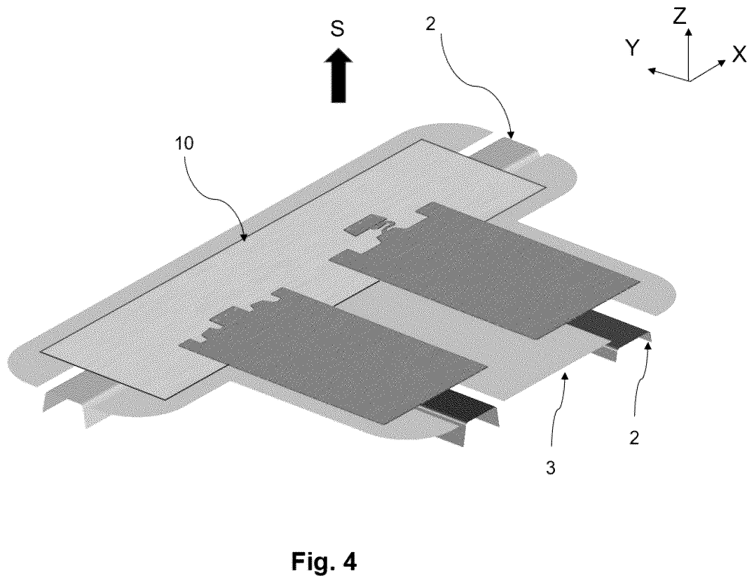

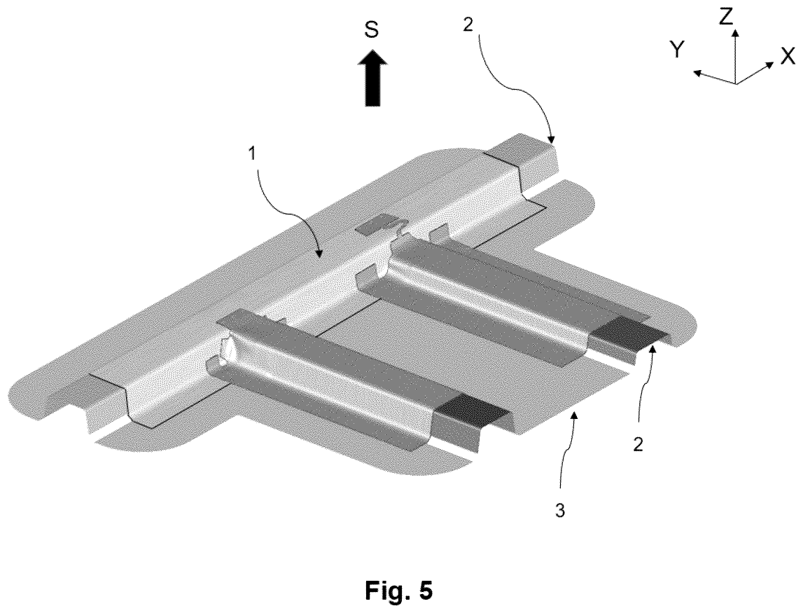

The stamping of a flexible blank according to the invention is represented on FIGS. 4 and 5. FIG. 4 represents the start of the stamping operation at which point the flexible blank 10 is fed to the stamping tool-on FIG. 4 the punch 2 and binder 3 are represented. The punch and the die close on to one another following the stamping direction S to form the metallic part at the end of the stamping operation, as represented on FIG. 5.

In a specific embodiment the stamping operation is a cold forming stamping. In a specific embodiment the stamping operation is hot stamping, optionally multi-step hot stamping, optionally partial hardening hot stamping.

The sub-blanks 101, 102 are assembled together in the fixed pre-assembly area 1002 which allows to manipulate them easily before stamping. For example, the sub-blanks are assembled by resistance spot welding them together in the pre-assembly area 1002 to form spot welds 1003, as depicted on FIG. 2. For example, the sub-blanks are assembled by laser welding them together, for example by remote laser welding them together in the pre-assembly area 1002. For example, the sub-blanks are assembled by gluing them together in the pre-assembly area 1002.

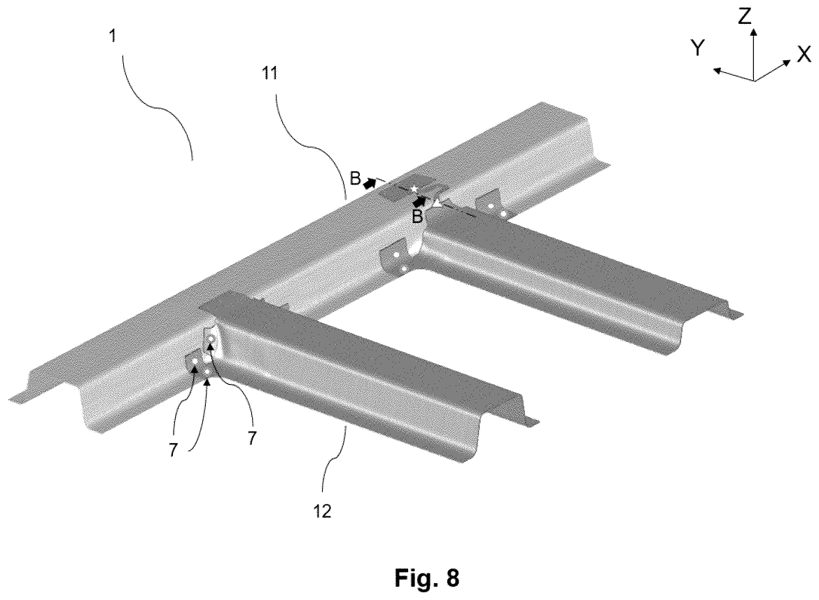

After the forming operation, the sub-parts are only assembled together in the fixed pre-assembly areas 1002, which can be the cause of a structural weakness of the metallic part. It is interesting to further assemble the formed sub-parts to increase the structural strength of the final part. In a specific embodiment, as depicted on FIG. 2, the sliding area 1001 of the overlap area 100 of the sub-blanks further comprises at least one post-assembly area 1004 in which said first and second sub-parts 11, 12 are still overlapping one another after said stamping operation. In this specific embodiment, the manufacturing process further comprises a post-assembly step after the stamping operation during which at least said first and second sub-parts are joined together in said post-assembly areas 1004. For example, the sub-parts are joined together by spot welding them together to form spot welds 7 as depicted in FIG. 8. For example, the sub-parts are laser welded, optionally remote laser welded together.

For example, when applying the current invention to a metallic part of an automotive vehicle, this allows to integrate in one single metallic part both longitudinal and transverse structural elements. For example, this allows to integrate in one single part longitudinal front side members and a dash panel cross member. For example, this allows to integrate in one single part side sills and seat cross members. For example, this allows to integrate in one single part roof rails and roof cross members. For example, this allows to integrate in one single part rear side members and rear cross members. By combining various structural elements in one single part, the manufacturing process is simplified, and the part is made more robust because its longitudinal and transverse components are integral to the same part and therefore cooperate together in an optimal manner.

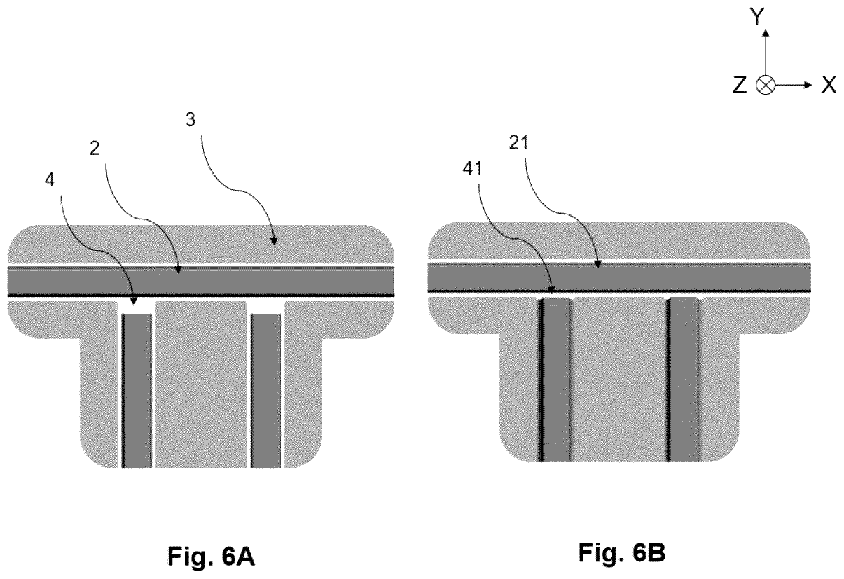

In a particular embodiment, the stamping step is followed by a conforming step in which the shape of the metallic part is further adjusted in the transition areas 11T12. Indeed, because of the presence of the gap 4 in the stamping tool punch 2, the blank material in the transition areas 11T12 corresponding to the gap in the punch is not pressed against the die. The shape of the metallic part in this area will thus not perfectly reproduce that of the die. In a particular embodiment, as represented on FIGS. 6A and 6B, a conforming tool is used having a punch 21 with a smaller gap 41 between the areas corresponding to said first and second sub-parts. FIG. 6A represents a stamping punch 2 according to the invention with a gap 4 and FIG. 6B represents a conforming punch 21 according to the invention with a smaller conforming punch gap 41. By reducing the gap 41 within the conforming tool, the material is pressed more closely into the die and therefore better conforms to the desired shape in the transition areas 11T12. It is possible to reduce the gap 41 in the conforming tool because the part is already formed by stamping and the forces exerted by the conforming operation on the rest of the part will be much lower than during stamping, in such a way that no cracks will occur in the transition areas. In any case it will still be necessary to have a conforming gap 41 which is greater than 0 mm. In a particular embodiment, the length of the confirming gap 41 is comprised from 10% to 80% of the length of the initial stamping punch gap 4, preferably from 10% to 70%, preferably from 10% to 50%, preferably from 20% to 70%, preferably from 20% to 50%.

In a particular embodiment, the stamping operation and the conforming operation are performed as two successive stages of a transfer press. For example, they are performed as two successive stages of a cold stamping transfer press. For example, they are performed as two successive stages of a hot stamping multistep process using a transfer press.

In a particular embodiment, the stamping operation and the conforming operation are performed successively using an adjustable punch in which the gap 4 at the stamping stage can be reduced to the gap 41 at the conforming stage for example by sliding the punch element corresponding to the sub-part 2 closer to the punch element corresponding to sub-part 11.

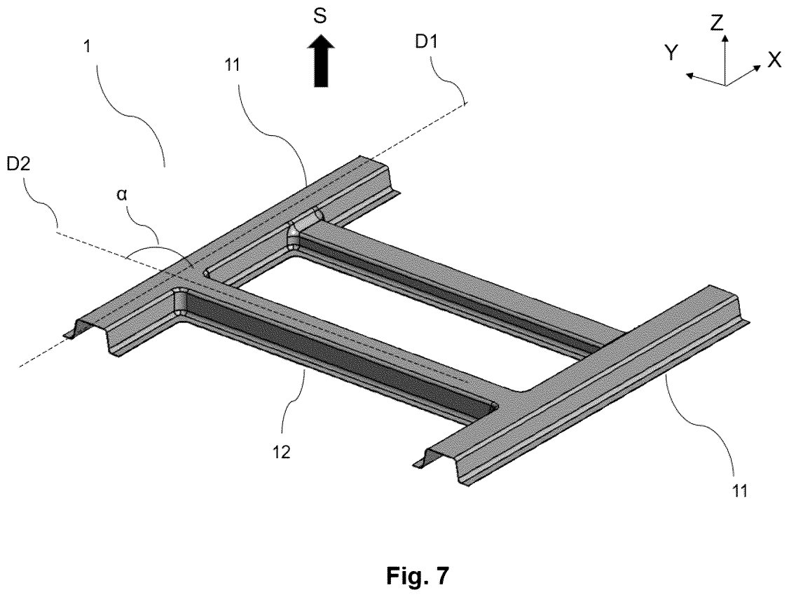

The above-described configuration of the metallic part, comprising at least a first and a second sub-part 11, 12 should be understood as the most basic possible configuration of a metallic part according to the invention. Referring to FIG. 7, said metallic part 1 can for example comprise at least two first sub-parts 11 generally extending along said first direction D1, each being connected to said at least one second sub-part 12 generally extending along said second direction D2. In this case, the flexible metallic blank 10 comprises at least three sub-blanks substantially corresponding to each of said sub-parts, said flexible blank further comprising at least two overlap areas in which each sub-blank extending in a first direction overlap the sub-blank extending in a second direction, each of said overlap areas comprising at least a fixed area and a sliding area. Furthermore, the stamping tool used to manufacture said metallic part will comprise a punch 2 having in this case at least two gaps 4 each corresponding to an area in between first sub-parts 11 and the second sub-part 12.

Any other combination between first and second sub-parts extending along directions D1 and D2 is also possible according to the invention. Indeed, the gist of the invention is to provide a manufacturing process that allows to form the blank material in the transition regions 11T12 without the occurrence of cracks.

In fact, the invention can be generalized to metallic part configurations in which there are even more than two main direction D1, D2. Indeed, the stamping issues solved by the invention occur locally in each transition region 11T12 and each set of transition region is in fact independent from the others.

In a particular embodiment, as depicted on the top part of FIG. 1, the top sections 113 and 123 of the first and second sub-parts extend at different elevation levels, in other words the difference in elevation levels dz, as represented on the top of FIG. 1, is different than 0. This type of configuration is very usual for structural parts, e.g. for an automotive structural parts, because the strength requirement can vary in the different directions and with these requirements the height of the vertical walls of the different sub-parts will be adjusted—furthermore, in the case of a complex structure, such as a vehicle structure, the structural parts need to fit in to a determined volume, which can limit the height of the walls in certain areas of the part. The inventors have found that this difference in elevation can lead to failure of the part during stamping. Indeed, the material in the sliding area 1001 needs to move a considerable amount in order to accommodate for the elevation difference dz, whereas the material in the fixed pre-assembly area 1002 cannot move during stamping. The important shearing forces thus generated between the two sub-blanks can put excessive strain on the assembly points in the fixed pre-assembly area 1002 leading to failure of the assembly. Or else, if the pre-assembly points do not fail, the material in the corresponding high deformation zone of the sliding area can fail due to excessive thinning or cracking. These issues are even more significant if the difference in elevation dz is important.

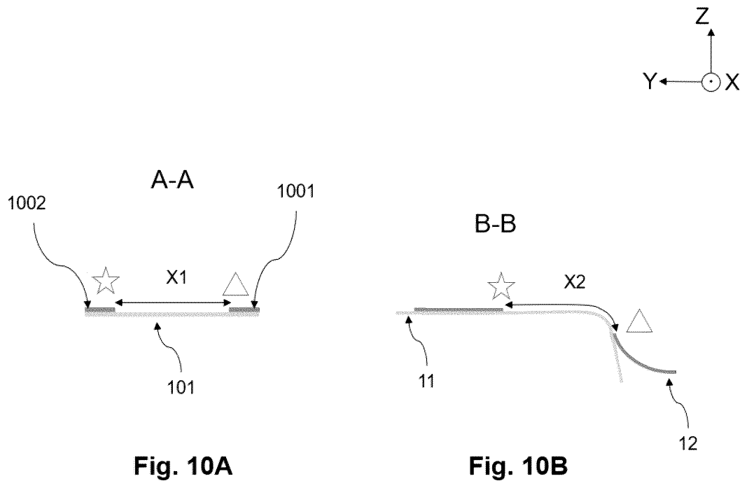

Referring to FIGS. 2, 8, 10A and 10B the above-described problem is illustrated by the variation in distance between two points represented on the figures by a star and a triangle. The first point, represented by a star, belongs to the fixed pre-assembly area 1002 of the flexible blank and is located in an area corresponding to the top section 113 of the first sub-part. The second point, represented by a triangle, belongs to the sliding area 1001 of the flexible blank and is located in an area corresponding to the top section 123 of the second sub-part. In the current description, the term “distance” designates the shortest path between two points as measured along the blank or the metallic part. The distance between the two said points is X1 on the flexible blank, before stamping, and X2 on the metallic part, after stamping. Because of the difference in elevation dz between the top sections 113 and 123, which is imparted during the stamping operation, the distance between said points must at least be increased by dz, in other words X2≥X1+dz.

The inventors have found that it was possible to solve this issue by providing in the overlap area 100 an extensible area 1005 connecting said fixed pre-assembly area 1002 and said sliding area 1001, wherein said pre-assembly area has a resistance to shear strength RS, expressed in MPa, said extensible area has a resistance to plastic deformation RP, expressed in MPa, and wherein RP<RS. Said resistance to shear strength RS of the fixed pre-assembly area 1002 is defined as being the stress, measured in MPa, necessary to break the assembly between the two sub-blanks 101, 102, when applying said stress on one side on sub-blank 101 and on the other side on sub-blank 102 in the direction of the force that is generated during the stamping operation. In a similar way, said resistance to plastic deformation RP of the extensible area 1005 is defined as being the stress, measured in MPa, necessary to set off the plastic deformation of the extensible area 1005 when applying said stress on one side on sub-blank 101 and on the other side on sub-blank 102 in the direction of the force that is generated during the stamping operation.

During stamping, the extensible area 1005 will start to deform before the shear strength exerted on the pre-assembly area reaches the critical RS value. This deformation of the extensible area will in turn lower the shear strength exerted on the pre-assembly area, because the contradiction between the movement of the sliding area and of the fixed pre-assembly area is resolved by the elongation of the extensible area. The extensible area therefore protects the pre-assembly area and solves the above-described issue of decohesion within the pre-assembly area.

An iterative set of stamping simulations can be performed to successfully design said extensible area 1005. For example, in a first iteration, a first extensible area 1005 is provided, the stamping operation is simulated and the resulting RP and RS are deduced from the stamping simulation (these elements can be provided by the stamping simulation software which is used). If RP Is greater than RS, i.e. the assembly in the fixed pre-assembly area 1002 fails before the extensible area starts to flow in plastic deformation, than either RS is increased by providing for a stronger assembly (for example, adding spot welds in the case of a spot welded assembly) or RP is decreased (for example lowering the thickness of the extensible area, or using a material having lower yield point or adjusting the geometry of said extensible area 1005) or both. A further stamping simulation is then performed and the same necessary are done if again RP is greater than RS, incrementally so until the desired situation of a flexible configuration in which RP<RS is reached.

For example, if spot welds 1003 are used to assemble the sub-blanks 101, 102 in the fixed pre-assembly area 1002, the mechanical behavior of said spot welds can be simulated in the following way by applying the method developed in the Fosta 806 project: “P 806—Characterization and simplified modeling of the fracture behavior of spot welds from ultra-high strength steels for crash simulation with consideration of the effects of the joints on component behavior” (Fosta stands for “Forschungsvereinigung Stahlanwendung”, i.e. The Research Association for Steel Application). The failure behavior and associated deleted elements calculation can be simulated using the material cards MAT123 and MAT_ADD_EROSION. Further explanation on the methodology can be found for example in “Simulation of Spot Welds and Weld Seams of Press-Hardened Steel (PHS) Assemblies”, Stanislaw Klimek, International Automotive Body Congress 2008.

The above-described method of adjusting RP and RS using stamping simulation can also be performed using a physical stamping tool in which the design is adjusted, even though this method, involving actual physical testing and the iterative production of adjusted actual physical flexible blanks, might prove more time consuming and costly than the numerical simulation method.

In a particular embodiment, said extensible area 1005 is characterized by the fact that the length of said extensible area measured along the formed metallic part in between the point where it is connected to the fixed area and the point where it is connected to the sliding area increases after said stamping operation. In the attached figures, the star and triangle of FIGS. 2, 8, 10A and 10B correspond to the above-mentioned attachment points of the extensible area 1005 respectively to the fixed area 1002 and to the sliding area 1001. The term attachment point should be understood generically to be an attachment area, not limited to a one-dimensional point, and possibly covering a more or less large part of the extremities of said fixed and sliding areas 1002, 1001.

The exact configuration of the extensible area 1005 will depend on the design of the part, structural requirements, available tooling etc. For example, as represented on the attached figures, said extensible area can be made of the same material as the rest of the corresponding sub-blank using a convoluted shape on the flexible blank, such as an S-shape, which is then at least partially straightened out during stamping.

Other means of implementing the extensible area 1005 include for example the use of a multi-material sub-blank in which the material of the extensible area 1005 has a very high formability (possibly with a lower mechanical resistance). For example, this is done by using a tailor welded blank with different materials for the extensible area and the other areas. Another possibility is to provide material having a lower thickness in the extensible area 1005, which will lower the resistance to plastic deformation of said area.

For example, the extensible area 1005 is made of folded up material in a shape resembling an accordion which will unfold under the forces exerted during the stamping operation. Because the necessary strength to unfold a sheet is usually less than that necessary to extend it, this can be a way of lowering the RP of said extensible area.

The current invention further covers a metallic part corresponding to the above listed features taken alone or according to any possible combinations and manufactured by the above detailed process, including all possible combinations of optional features of said process.

One significant advantage of said metallic part manufactured according to said process is that it is possible, in a specific embodiment, to manufacture a metallic part comprising at least one set of contiguous sub-parts having at least one set of two contiguous vertical walls, e.g. 112 and 121, wherein the curvature radius measured in the transition area 11T12 between said two contiguous vertical walls is extremely low. This is not possible in the prior art stamping technique, without a flexible blank, because the shape in the transition region needs to be soft, i.e. with a high curvature radius, in order to provide a progressive change in flow direction of the material composing said contiguous vertical walls. For example, in a specific embodiment, the curvature radius measured in the transition area 11T12 between said two contiguous vertical walls is equal to or less than twenty times, more specifically less than ten times, even more specifically less than five times, the smallest sheet metal thickness of said two sub parts. In a specific embodiment, said curvature radius is less than 100 mm, more specifically less than 50 mm, more specifically less than 20 mm, more specifically less than 10 mm, more specifically less than 5 mm. In a specific embodiment, said curvature radius is 0 mm, meaning that said sub-parts form a sharp angle with one another. Providing a metallic structural part with low or even no curvature radius between contiguous side walls allows for optimal resistance of the part in the case of compressive stresses for example in which the different sub-parts extending in different directions need to cooperate with one another to resist compression. For example, in the case of automotive structural parts, this is advantageous to resist with the same parts transverse crashes and longitudinal crashes.

In a specific embodiment the metallic part 1 is made by cold stamping a flexible blank 10 comprising one of the following materials, either in the form of monolithic blanks or tailor rolled blanks or combined in the form of tailor welded blanks:
Steel having a chemical composition comprising in weight %: 0.13%<C<0.25%, 2.0%<Mn<3.0%, 1.2%<Si<2.5%, 0.02%<Al<1.0%, with 1.22%<Si+Al<2.5%, Nb<0.05%, Cr<0.5%, Mo<0.5%, Ti<0.05%, the remainder being Fe and unavoidable impurities and having a microstructure comprising from 8% to 15% of retained austenite, the remainder being ferrite, martensite and bainite, wherein the sum of martensite and bainite fractions is comprised from 70% to 92%. With this composition, the steel sheet has, as measured in the rolling direction, a yield strength comprised from 600 MPa to 750 MPa and an ultimate tensile strength comprised from 980 MPa to 1300 MPa while keeping a total elongation above 19%.
Steel having a chemical composition comprising in weight %: %: 0.15%<C<0.25%, 1.4%<Mn<2.6%, 0.6%<Si<1.5%, 0.02%<Al<1.0%, with 1.0%<Si+Al<2.4%, Nb<0.05%, Cr<0.5%, Mo<0.5%, the remainder being Fe and unavoidable impurities and having a microstructure comprising from 10% to 20% of retained austenite, the remainder being ferrite, martensite and bainite. With this composition, the steel sheet has, as measured in the rolling direction, a yield strength comprised from 850 MPa to 1060 MPa and an ultimate tensile strength comprised from 1180 MPa to 1330 MPa while keeping a total elongation above 13%.
Fully martensitic steel wherein the composition of the fully martensitic steel comprises in % weight: 0.15%≤C≤0.5%.
Dual phase steel having a microstructure comprising at least martensite and ferrite and having a UTS of at least 590 MPa.
Dual phase steel having a microstructure comprising at least martensite and ferrite and having a UTS of at least 780 MPa.
Dual phase steel having a microstructure comprising at least martensite and ferrite and having a UTS of at least 980 MPa.

In a specific embodiment the metallic part is made by hot stamping a flexible blank 10 comprising one of the following materials, either in the form of monolithic blanks or tailor rolled blanks or combined in the form of tailor welded blanks:
Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised from 700 to 950 MPa, the tensile strength from 950 MPa to 1200 MPa and the bending angle is above 75°.
Steel having an ultimate tensile strength after hot stamping which is comprised from 1300 MPa to 1650 MPa and a yield strength which is comprised from 950 MPa to 1250 MPa.
Steel having an ultimate tensile strength after hot stamping which is comprised from 1300 MPa to 1650 MPa, a yield strength which is comprised from 950 MPa to 1250 MPa and a bending angle which is above 75°.
Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised from 1300 MPa to 1650 MPa and the yield strength is comprised from 950 MPa to 1250 MPa.
Steel having a tensile strength after press-hardening higher than 1800 MPa.
Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0,005%, P≤0,025%, %, the remainder being iron and unavoidable impurities resulting from the elaboration. With this composition range, the tensile strength of the corresponding area after hot stamping is higher than 1800 MPa.
Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting.
Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area after hot stamping is higher than 1350 MPa and the bending angle is higher than 70°.
Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding area after hot stamping is equal to or higher than 1000 MPa and the bending angle is higher than 55°.
Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114−68*C−18*Mn+20*Si−56*Cr−60*Ni−36*Al+38*Mo+79*Nb−17691*B<20, the remainder of the composition being iron and unavoidable impurities resulting from the smelting. For example, this composition is used when hot stamping the part using a multistep process.
Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turn allows to produce the parts by hot stamping without a subsequent sand blasting operation. Furthermore, the aluminum-based coating also provides corrosion protection to the metallic part while in service, for example on an automotive vehicle.
Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least one element of the rear structure is made by hot stamping a laser welded blank comprising at least one sub blank having an aluminum based metallic coating and said aluminum coated sub-blanks are prepared before-hand by ablating at least part of the metallic coating on the edges to be welded. Advantageously, this removes part of the aluminum present in the coating, which would pollute the weld seam and deteriorate its mechanical properties.

In a particular embodiment, at least one sub-blank of the flexible blank 10 comprises at least one area having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

The current invention further covers a metallic part on the body of an automotive vehicle corresponding to the above listed features taken alone or according to any possible combinations and manufactured by the above detailed process, including all possible combinations of optional features of said process.

The current invention further covers the use of such a metallic part to assemble an automotive vehicle body.

The current invention further covers an automotive vehicle comprising at least one such metallic part.

What is claimed is:

1-18. (canceled)

19: A manufacturing process to produce a metallic part by stamping a flexible metallic blank according to a stamping direction, the metallic part comprising at least:
a first sub-part extending along a first direction perpendicular to the stamping direction, and comprising at least one first side wall parallel to the stamping direction, connected to a first top section extending in a plane perpendicular to the stamping direction,
a second sub-part connected to said first sub-part and extending along a second direction perpendicular to the stamping direction and forming with the first direction an angle α strictly greater than 0°, comprising at least two vertical walls, parallel to the stamping direction, and a second top section connecting the two vertical walls and extending in a plane perpendicular to the stamping direction,
the flexible metallic blank comprising at least:
first and second sub-blanks each corresponding to the first and second sub-parts,
at least one overlap area where the first and second sub-blanks overlap one another, the overlap area comprising at least one sliding area where the first and second sub-blanks are free to slide on to one another during the stamping operation and a fixed pre-assembly area where the first and second sub-blanks cannot move relative to one another during the stamping operation,
the manufacturing process comprising at least the steps of:
providing the first and second metallic sub-blanks;
pre-assembling the first and second metallic sub-blanks in the fixed pre-assembly area to form the flexible flat metallic blank;
performing a stamping operation by pressing the flexible metallic blank between a punch and a die moving relative to one another in the stamping direction, the punch comprising at least one gap in between areas corresponding to the first and second sub-parts.

20: The manufacturing process as recited in claim 19 wherein the angle α is from 30° to 90°.

21: The manufacturing process as recited in claim 20 wherein the angle α is from 60° to 90°.

22: The manufacturing process as recited in claim 21 wherein the angle α comprised from 80° to 90°.

23: The manufacturing process as recited in claim 19 wherein the sub-blanks are assembled together in the fixed pre-assembly area by spot welding.

24: The manufacturing process as recited in claim 19 wherein the sub-blanks are assembled together in the fixed pre-assembly area by laser welding.

25: The manufacturing process as recited in claim 19 wherein the stamping operation is performed by hot stamping.

26: The manufacturing process as recited in claim 19 wherein the stamping operation is performed by cold stamping.

27: The manufacturing process as recited in claim 19 wherein the sliding area further comprises at least one post-assembly area where the first and second sub-parts are still overlapping one another after the stamping operation is performed and wherein the manufacturing process further comprises a post-assembly step after the stamping operation where the first and second sub-parts are joined together in the at least one post-assembly area.

28: The manufacturing process as recited in claim 27 wherein said post-assembly step is performed by spot welding.

29: The manufacturing process as recited in claim 27 wherein the post-assembly step is performed by laser welding.

30: The manufacturing process as recited in claim 19 wherein the stamping operation is followed by a conforming operation using a conforming punch comprising a conforming gap in between the areas corresponding to the first and second sub-parts, the conforming gap being smaller than the at least one gap.

31: The manufacturing process as recited in claim 19 wherein the metallic part comprises a further first sub-part extending along said first direction and connected to the second sub-part or a further second sub-part extending along the second direction, wherein the flexible metallic blank comprises at least a further sub-blank corresponding to the further first sub-part, the flexible blank further comprising a further overlap area where the further first sub-art overlaps the second sub-part or a further second sub-part, the further overlap area comprising at least a further fixed pre-assembly are and a further sliding area.

32: The manufacturing process as recited in claim 19 wherein the first and second sub-parts have top sections extending at different elevation levels and wherein the overlap area between the first and second sub-blanks further comprises an extensible area connecting the fixed pre-assembly area and the sliding area, wherein said fixed pre-assembly area has a resistance to shear strength RS, expressed in MPa, said extensible area has a resistance to plastic deformation RP, expressed in MPa, and wherein RP<RS.

33: A metallic part manufactured according to claim 19.

34: The metallic part as recited in claim 33 comprising at least one set of contiguous sub-parts having at least one set of two contiguous vertical walls wherein the curvature radius measured in the transition area between said two contiguous vertical walls is equal to or less than twenty times the smallest thickness of said two sub parts.

35: The metallic part as recited in claim 33, the metallic part designed to be a body part of an automotive vehicle.

36: An automotive vehicle comprising the metallic part as recited in claim 35.
